(19) United States
(12) Patent Application Publication
(10) Pub. No.: US 2026/0236857 A1
(43) Pub. Date: Aug. 13, 2026

(54) Contextualized Commerce System and Method for Property Reservations, with Dynamic Pricing

(71) Applicant: Roomer Travel Inc., Boca Raton, FL (US)

(72) Inventors: Peleg Cohen, Nahariya (IL); Gon Ben David, Givat Elah (IL)

(73) Assignee: Roomer Travel Inc., Boca Raton, FL (US)

(21) Appl. No.: 19/161,303

(22) PCT Filed: Feb. 28, 2024
(86) PCT No.: PCT/IB2024/051887

§ 371 Date: Sep. 1, 2025

Related U.S. Application Data
(60) Provisional application No. 63/449,937, filed on Mar. 3, 2023.
(60) Provisional application No. 63/526,248, filed on Jul. 12, 2023.

(51) Int. Cl. G06Q 10/02; G06Q 30/0207

(52) U.S. Cl. CPC G06Q 10/0285; G06Q 30/0207

(57) ABSTRACT

In a computer system with a booking platform and databases, a method involves obtaining and verifying media from a user, forming associations between the user, media, and a location, and determining a link for the media. The link is provided to the user. When another user selects the link, they are directed to a server associated with the booking platform, where they receive information about properties at the location. If the second user makes a reservation for a specific property, the first user is provisionally rewarded. The provisional reward remains unredeemable until the reservation is used. The amount of redeemable reward is based on the price actually paid for the particular property. The property information includes dynamically determined pricing, and a dynamically priced refund option is offered. Dynamic property pricing information and/or dynamic refund option pricing may be performed in real-time in response to a user selecting a link.

### RELATED APPLICATIONS

This application claims the benefit of U.S. patent applications Nos. 63/449,937, filed Mar. 3, 2023, and 63/526,248, filed Jul. 12, 2023, the entire contents of each of which are hereby fully incorporated herein by reference for all purposes.

### COPYRIGHT STATEMENT

This patent document contains material subject to copyright protection. The copyright owner has no objection to the reproduction of this patent document or any related materials in the files of the United States Patent and Trademark Office, but otherwise reserves all copyrights whatsoever.

### SOURCE CODE APPENDIX

This application includes a source code appendix with an example of computer source code. The source code appendix is considered part of this application for all purposes.

### FIELD OF THE INVENTION

This invention generally relates to property reservation systems and, more particularly, to online property reservation systems using contextualized commerce and rewarding influencers.

### BACKGROUND

Booking accommodations online has become ubiquitous. Online booking allows users to compare prices, read reviews, and select their preferred accommodation.

One benefit of booking accommodations online is comparing prices easily from multiple sources. Users can compare rates from different websites and the hotel's website to ensure they get the best deal possible. With a vast selection of hotels, users can also compare amenities, locations, and reviews to make an informed decision about their accommodations.

It is desirable, and an object of this invention, to provide a system that allows users to compare amenities, locations, and reviews to make an informed decision about their accommodations. It is also desirable, and an object hereof, to provide a system that rewards users who recommend or otherwise influence other users' purchasing or renting decisions. It is also desirable, and a further object hereof, to provide dynamically priced accommodations.

### SUMMARY

The present invention is specified in the claims and the description.

In some aspects, a framework (via booking system), according to exemplary embodiments hereof, allows users to find and book (i.e., reserve) properties for lodging or other purposes.

A system of one or more computers can be configured to perform particular operations or actions by virtue of having software, firmware, hardware, or a combination of them installed on the system that, in operation, causes or cause the system to perform the actions. One or more computer programs can be configured to perform particular operations or actions by virtue of including instructions that, when executed by a data processing apparatus, cause the apparatus to perform the actions.

One general aspect includes a computer-implemented method in a framework comprising a booking platform having one or more computer systems storing information in one or more databases. The method includes (a)(1) obtaining media from a first user. The method also includes (a)(2) verifying the media obtained in (a), and, based on the verifying, otherwise, when the media fails the verifying, terminating. The method also includes (b)(1) forming and maintaining (i) a first association between the first user and the media and (ii) a second association between the media and a location. The method also includes (b)(2) determining a link for the media. The method also includes (b)(3) maintaining (iii) a third association between the first user and the link and (iv) a fourth association between the link and the media. The method also includes (b)(4) providing the link to the first user. The method also includes (c)(1) in response to a second user selecting the link, where the link was presented to the second user in combination with the media, directing the second user to a server associated with the booking platform, the server presenting the second user with information about one or more properties at the location. The method also includes (c)(2) in response to the second user making a reservation for a particular property of the one or more properties, provisionally rewarding the first user with a provisional reward, where the provisional reward is unredeemable until the reservation is used. Other embodiments of this aspect include corresponding computer systems, apparatus, and computer programs recorded on one or more computer storage devices, each configured to perform the actions of the methods.

Implementations may include one or more of the following features, alone or in combination(s):
The computer-implemented method may include: (d) in response to the reservation being used, converting the provisional reward to a redeemable reward.
The verifying in (a)(2) may include one or more of (i) checking the media for illegal content, and/or (ii) checking the media for unauthorized or unlicensed content; and/or (iii) checking whether the media violates terms of service of the booking platform; and/or (iv) checking whether the media is already stored in the booking platform; and/or (v) checking whether the media is from the location or was acquired at the location.
The information about one or more properties at the location may include pricing information for the one or more properties.
The pricing information for the one or more properties may include dynamic pricing information for the one or more properties.
The dynamic pricing information was determined based on one or more factors.
For a particular property of the one or more properties, the one or more factors include one or more of (i) a market price of the particular property, (ii) a chance of selling the particular property, and/or (iii) rental and pricing history of the particular property.
Dynamic pricing information was determined after the second user selected the link.
Dynamic pricing information for the one or more properties was determined in response to the second user selecting the link.
Where, for at least some of the one or more properties at the location, the information includes a corresponding refund option, including a refund amount and a refund fee.
A particular refund option for a particular property was determined after the second user selected the link.
The particular refund option for the particular property was determined in response to the second user selecting the link.
Where the refund fee for the particular property was determined based on one or more of the following: a price for the particular property; and/or time to check-in; and/or a length of stay associated with the particular property; and/or a probability of reselling the particular property; and/or a probability and/or rate of activation for the particular property; and/or an expected price and/or rate of resale of the particular property; and/or a desired profit margin; and/or location of the particular property; and/or amounts to be paid to partners; and/or the refund amount.
Where the price was determined after the second user selected the link.
The media may include one or more photographs, images, videos, web pages, music, audio, text, commentaries, and/or graphics, alone or in combination.
One or more properties are selected from: hotels, motels, flats, apartments, houses, rooms, cabins, camping sites, campgrounds, buildings, and tents.
The framework maintains a list of canceled-and-still-usable reservations, where one or more properties may include one or more canceled-and-still-usable reservations.
One or more properties are selected from properties in an inventory of the framework and/or properties from one or more external suppliers.
One or more external suppliers are selected from travel agents, travel booking websites, and property owners or operators.

The dynamic property pricing information and/or the dynamic refund option pricing may be done in real-time in response to a user searching for a property.

Implementations of the described techniques may include hardware, a method or process, or computer software on a computer-accessible medium.

Below, further numbered embodiments of the invention will be discussed.

Below is a list of method (or process) embodiments. Those embodiments will be indicated with the letter “P.” Whenever such embodiments are referred to, this will be done by referring to “P” embodiments.
P1. A computer-implemented process in a framework comprising a booking platform having one or more computer systems storing information in one or more databases, the process comprising:
(A)(1) obtaining media from a first user;
(A)(2) verifying the media obtained in (A), and, based on the verifying, when the media fails the verifying, terminating, otherwise,
(B)(1) forming and maintaining:
   (i) a first association between the first user and the media; and
   (ii) a second association between the media and a location;
(B)(2) determining a link for the media;
(B)(3) maintaining:
   (iii) a third association between the first user and the link; and
   (iv) a fourth association between the link and the media;
(B)(4) providing the link to the first user;
(C)(1) in response to a second user selecting the link, where the link was presented to the second user in combination with the media, directing the second user to a server associated with the booking platform, the server presenting the second user with information about one or more properties at the location; and
(C)(2) in response to the second user making a reservation for a particular property of the one or more properties, provisionally rewarding the first user with a provisional reward, wherein the provisional reward is unredeemable until the reservation is used.
P2. The computer-implemented process of process embodiment(s) P1, further comprising:
(D) in response to the reservation being used, converting the provisional reward to a redeemable reward.
P3. The computer-implemented process of process embodiment(s) P1-P2, wherein the verifying in (A)(2) comprises one or more of:
(i) checking the media for illegal content; and/or
(ii) checking the media for unauthorized or unlicensed content; and/or
(iii) checking whether the media violates terms of service of the booking platform; and/or
(iv) checking whether the media is already stored in the booking platform; and/or
(v) checking whether the media is from the location or was acquired at the location.
P4. The computer-implemented process of any of the process embodiments, wherein the information about one or more properties at the location comprises pricing information for the one or more properties.
P5. The computer-implemented process of the process embodiment(s), wherein pricing information for the one or more properties comprises dynamic pricing information for the one or more properties.
P6. The computer-implemented process of process embodiment(s) P5, wherein the dynamic pricing information was determined based on one or more factors.
P7. The computer-implemented process of process embodiments P4-P5, wherein the dynamic pricing information was determined after the second user selected the link.
P8. The computer-implemented process of any of process embodiments P4-P7, wherein the dynamic pricing information for the one or more properties was determined in response to the second user selecting the link.
P9. The computer-implemented process of any of process embodiments P6-P8, wherein, for a particular property of the one or more properties, the one or more factors include one or more of (i) a market price of the particular property, (ii) a chance of selling the particular property, and/or (iii) rental and pricing history of the particular property.
P10. The computer-implemented process of any of the process embodiments, wherein, for at least some of the one or more properties at the location, the information includes a corresponding refund option, including a refund amount and a refund fee.
P11. The computer-implemented process of process embodiment(s) P10, wherein a particular refund option for a particular property was determined after the second user selected the link.
P12. The computer-implemented process of any of the process embodiments P10 or P11, wherein the particular refund option for the particular property was determined in response to the second user selecting the link.
P13. The computer-implemented process of any of the process embodiments P10-P12, wherein the refund fee for the particular property was determined based on one or more of the following:
(a) a price for the particular property; and/or
(b) time to check-in; and/or
(c) a length of stay associated with the particular property; and/or
(d) a probability of reselling the particular property; and/or
(e) a probability and/or rate of activation for the particular property; and/or
(f) an expected price and/or rate of resale of the particular property; and/or
(g) a desired profit margin; and/or
(h) location of the particular property; and/or
(i) amounts to be paid to partners; and/or
(j) the refund amount; and/or
(k) dates for the stay; and/or
(l) the number of guests the property can accommodate; and/or
(m) when or how the reservation was purchased.
P14. The computer-implemented process of process embodiment(s) P13, wherein the price was determined after the second user selected the link.
P15. The computer-implemented process of any one of the process embodiments, wherein the media comprises one or more photographs, images, videos, web pages, music, audio, text, commentaries, and/or graphics, alone or in combination.
P16. The computer-implemented process of any one of the process embodiments, wherein the one or more properties are selected from: hotels, motels, flats, apartments, houses, rooms, cabins, camping sites, campgrounds, buildings, and tents.
P17. The computer-implemented process of any of the process embodiments, wherein the framework maintains a list of canceled-and-still-usable reservations and wherein the one or more properties comprise one or more canceled-and-still-usable reservations.
P18. The computer-implemented process of any of the process embodiments, wherein the one or more properties are selected from properties in an inventory of the framework and/or properties from one or more external suppliers.
P19. The computer-implemented process of process embodiment(s) P18, wherein the one or more external suppliers are selected from travel agents, travel booking websites, and property owners or operators.
P20. The computer-implemented process of any of the process embodiments, wherein the provisional reward for a particular property is based on a price for the particular property.
P21. The computer-implemented process of any of the process embodiments, wherein a redeemable reward is based on a price actually paid for the particular property.
P22. The computer-implemented process of any of the process embodiments, where dynamic property pricing information and/or dynamic refund option pricing are performed in real-time in response to a user searching for a property and/or selecting a link.

Below is a list of computer-readable medium embodiments. Those will be indicated with the letter “C.” Whenever such embodiments are referred to, this will be done by referring to “C” embodiments.
C23. A non-transitory computer-readable medium with one or more computer programs stored therein that, when executed by one or more processors of a device, cause the one or more processors to perform the operations of the method of any one of embodiments P1-P22.

Below is a list of article of manufacture embodiments. Those will be indicated with the letter “A.” Whenever such embodiments are referred to, this will be done by referring to “A” embodiments.
A24. An article of manufacture comprising non-transitory computer-readable media having computer-readable instructions stored thereon, the computer-readable instructions including instructions for implementing a computer-implemented process, the computer-implemented process operable on a device comprising hardware including memory and at least one processor and running a service on the hardware, the process comprising the computer-implemented process of any one of process embodiments P1-P22.

The above features and additional details of the invention are described further in the examples herein, which are intended to illustrate the invention further but are not intended to limit its scope in any way.

### BRIEF DESCRIPTION OF THE DRAWINGS

Other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification. None of the drawings are to scale unless specifically stated otherwise.

FIG. 1 depicts aspects of a framework for booking properties according to exemplary embodiments hereof;

FIG. 2 depicts aspects of a user's device for accessing the framework according to exemplary embodiments hereof;

FIGS. 3A-3H are data structures according to exemplary embodiments hereof;

FIG. 4 depicts aspects of a link associated with media according to exemplary embodiments hereof;

FIG. 5 depicts aspects of properties associated with media according to exemplary embodiments hereof;

FIGS. 6A-6D and 7A-7D are flowcharts depicting aspects of operation of a system according to exemplary embodiments hereof; and

FIG. 8 depicts aspects of computing according to exemplary embodiments hereof.

### DETAILED DESCRIPTION OF THE PRESENTLY PREFERRED EXEMPLARY EMBODIMENTS

In the following, exemplary embodiments of the invention will be described, referring to the figures. These examples are given to provide further understanding of the invention without limiting its scope.

A series of features and/or acts are described in the following description. The skilled person will appreciate that unless the context requires explicitly, the order of features and steps is not critical for the resulting configuration and its effect. Further, it will be apparent to the skilled person that irrespective of the order of features and acts, the presence or absence of time delay between acts can be present between some or all of the described acts.

Reference numerals have just been referred to for quicker understanding and are not intended to limit the scope of the present invention in any manner.

### Glossary and Abbreviations

As used herein, unless used otherwise, the following terms or abbreviations have the following meanings:
API means application programming interface;
GUI means graphical user interface;
UI means user interface; and
URL means Uniform Resource Locator.

The term “mechanism,” as used herein, refers to any device(s), process(es), service(s), or a combination thereof. A mechanism may be implemented in hardware, software, firmware, using a special-purpose device, or any combination thereof. A mechanism may be integrated into a single device, or it may be distributed over multiple devices. The various components of a mechanism may be co-located or distributed. The mechanism may be formed from other mechanisms. In general, as used herein, the term “mechanism” may thus be considered shorthand for the term(s) device(s) and/or process(es) and/or service(s).

The term “media,” as used herein, refers, without limitation, to photographs, images, videos, web pages, music, audio, text, commentaries, graphics, etc., alone or in combination. For example, without limitation, “media” may refer to a single photograph, multiple photographs, or a video, each with or without audio. When “media” comprises audio, the audio may include, e.g., speech, music, and background sounds, alone or in combination. The term “media” is not limited by the manner in which the content was acquired or generated. For example, “media” may be obtained by a camera, a microphone, or the like. “Media” may be edited or generated and may include animation. The term “media” is not limited by the manner, form, or protocol in which the media is stored.

### DESCRIPTION

The following detailed description is not intended to limit the current invention. Alternate embodiments and variations of the subject matter described herein will be apparent to those skilled in the art.

Exemplary methods and systems according to exemplary embodiments hereof are described with reference to the drawings.

### Overview and Structure

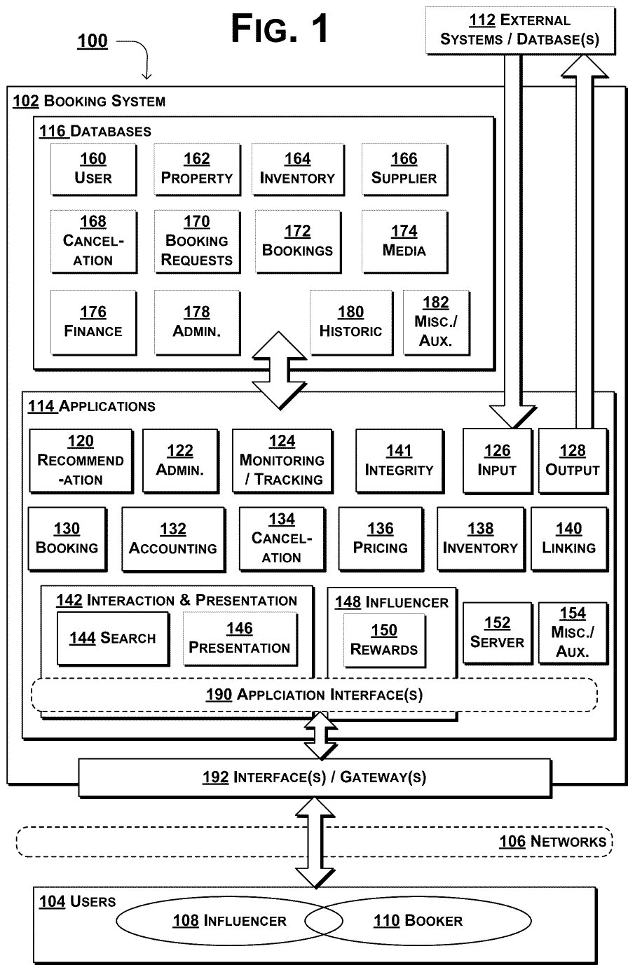

FIG. 1 shows aspects of an exemplary framework 100 for a property booking system 102 according to exemplary embodiments hereof. As shown in the drawing, a property booking system 102 (sometimes referred to as the “backend” or “backend platform”) may be accessed by users 104, e.g., via one or more networks 106 (e.g., the Internet). For example, as shown in FIG. 1, the users 104 may include influencers 108 and booking users 110. As should be appreciated and will become apparent upon reading this description, an influencer 108 may also be (or have been) a booking user 110 (as depicted by the intersection of the groups in the drawing). This list of types of users is exemplary; the users 104 may include different and/or other types of users.

As shown in FIG. 1, the property booking system 102 may comprise various mechanisms or applications 114 (e.g., in the form of software applications) and one or more databases 116, described in greater detail below. The mechanisms or applications 114 may interact with the one or more databases 116.

The database(s) 116 may comprise multiple separate or integrated databases, at least some of which may be distributed. The database(s) 116 may be implemented in any manner, and when made up of more than one database, the various databases need not all be implemented in the same manner. It should be appreciated that the system is not limited by the nature or location of the database(s) 116 or by how they are implemented.

Each application 114 is essentially a mechanism (as defined above, e.g., a software application) that may provide one or more services via an appropriate interface. Although shown as separate mechanisms for the sake of this description, it should be appreciated that some or all of the various mechanisms or applications 114 may be combined. The various mechanisms or applications 114 may be implemented in any manner and need not all be implemented in the same manner (e.g., with the same languages, interfaces, or protocols).

The mechanisms 114 may include one or more of the following mechanisms:
1. recommendation mechanism(s) 120
2. administrative mechanism(s) 122
3. monitoring and tracking mechanism(s) 124
4. Input mechanism(s) 126
5. Output mechanism(s) 128
6. Booking mechanism(s) 130
7. Accounting mechanism(s) 132
8. Cancelation mechanism(s) 134
9. Pricing mechanism(s) 136
10. Inventory mechanism(s) 138
11. linking mechanism(s) 140
12. integrity mechanism(s) 141
13. Interaction and presentation mechanism(s) 142, including search mechanism(s) 144 and presentation mechanism(s) 146;
14. Influencer mechanism(s) 148, including and rewards mechanism(s) 150;
15. Server mechanism(s) 152; and
16. Miscellaneous/auxiliary mechanisms 154.

Note that the above list of mechanisms/mechanisms is exemplary and is not intended to limit the scope of the system 100 in any way. Those of ordinary skill in the art will appreciate and understand, upon reading this description, that the system 100 may include any other types of data processing mechanisms and/or other types of mechanisms that may be necessary for the system 100 generally to perform its functionalities as described herein. In addition, as should be appreciated, embodiments or implementations of the system 100 need not include all of the mechanisms listed, and some or all of the mechanisms may be optional.

The database(s) 116 may include one or more of the following database(s):
1. User database(s) 160
2. Property database(s) 162
3. Inventory database(s) 164
4. Supplier database(s) 166
5. Cancelation database(s) 168
6. Booking request database(s) 170
7. Bookings database(s) 172
8. Media database(s) 174
9. Finance database(s) 176
10. Administrative database(s) 178
11. Historic database(s) 180
12. Miscellaneous and auxiliary database(s) 182

The above list of databases is exemplary and is not intended to limit the scope of the system 100 in any way.

As shown in FIG. 1, the property booking system 102 may access one or more external systems and databases 112. This access may include access via intake/input mechanism(s) 126, which may access external systems to obtain data therefrom. Access via output mechanism(s) 128 may be used to provide information (e.g., booking information) to the external systems and/or databases 112.

Monitoring and tracking mechanism(s) 124 may evaluate data (e.g., obtained from external systems and databases 112 and/or in the database(s) 116) to determine information therefrom.

Various mechanisms in the property booking system 102 may be accessible via application interface(s) 190. These application interface(s) 190 may be provided in the form of APIs or the like, made accessible to external users 104 via one or more gateways and interfaces 192. The gateways and interfaces 192 may be via one or more web pages and/or via applications (apps) running on user devices (e.g., tablet computers, smartphones, computers, or the like) and providing user interfaces (UIs), e.g., graphical user interfaces (GUIs) to the system.

The users 104 may have distinct roles and may be provided with role-specific access interfaces and/or mechanisms. For example, for influencers 108, the application interface(s) 190 (and/or interface(s) 192) may include an influencer-specific interface to the property booking system 102. In contrast, for booker/booking users 110, the application interface(s) 190 (and/or interface(s) 192) may include a booker-specific interface to the property booking system 102.

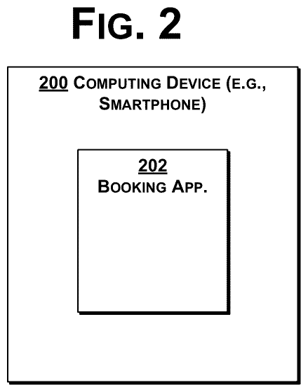

Each user 104 may access the property booking system 102 using one or more computing devices, as is known in the art. The property booking system 102 may also access and be accessed (or accessible) by or from various external systems and/or databases 112. For example, as shown in FIG. 2, a user may access the property booking system 102 via an app 202 on the user's computing device 200 (e.g., a smartphone).

The naming, categorization, and logical organization of the applications 114 and the database(s) 116 are to aid in this description and are not intended to limit the scope of the system in any way. Furthermore, the naming and categorization of the applications and/or databases provide a logical view of the system, whereas an implementation may combine various mechanisms or databases or organize them differently. Such different logical organizations of the applications and/or databases are within the scope hereof.

### Mechanisms and Data Structures

Details of various mechanisms, processes, data structures, and functionalities of an exemplary property booking system 102 are now described.

As noted above, in some aspects, a framework/system 100 (via booking system 102), according to exemplary embodiments hereof, allows users 104 to find and book (i.e., reserve) properties for lodging or other purposes.

As used herein, the term “property” refers to any kind of real property which may be rented or leased, in whole or in part, for any period (e.g., a number of hours, days, nights, weeks, months, etc.), and for any purpose (e.g., lodging). Non-limiting examples of properties include hotels, motels, flats, apartments, houses, rooms, cabins, camping sites, campgrounds, buildings, tents, etc. The system is not constrained by the kind of property, the purpose, or the duration.

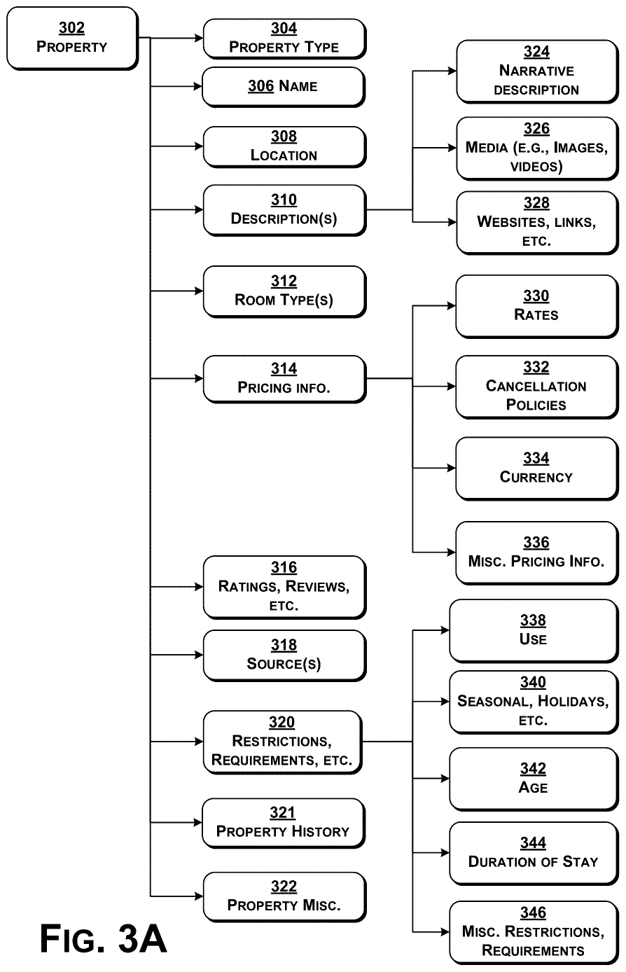

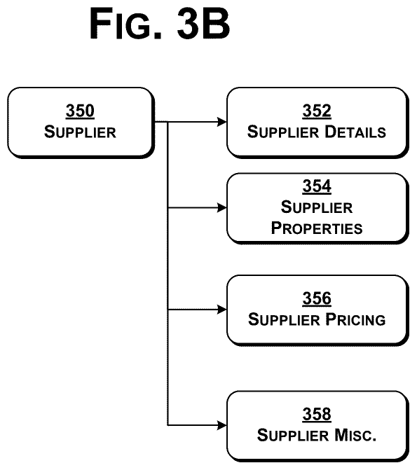

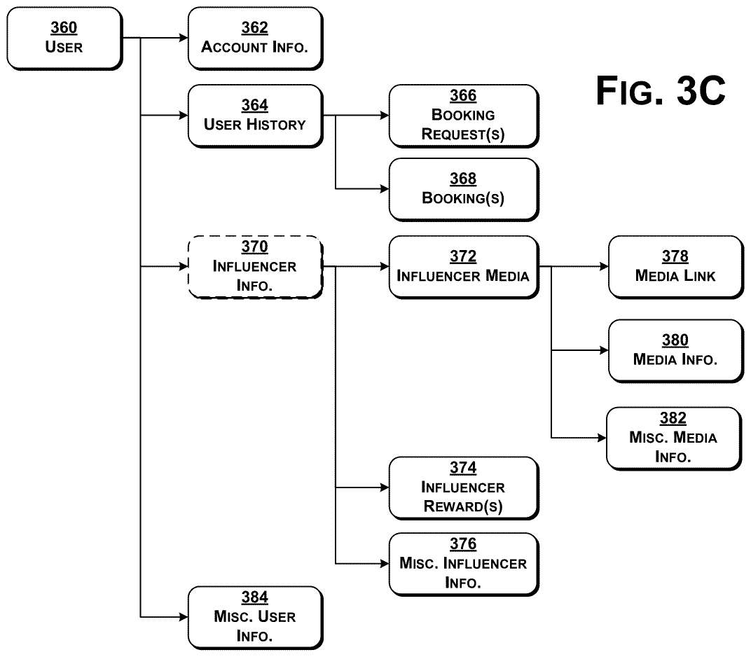

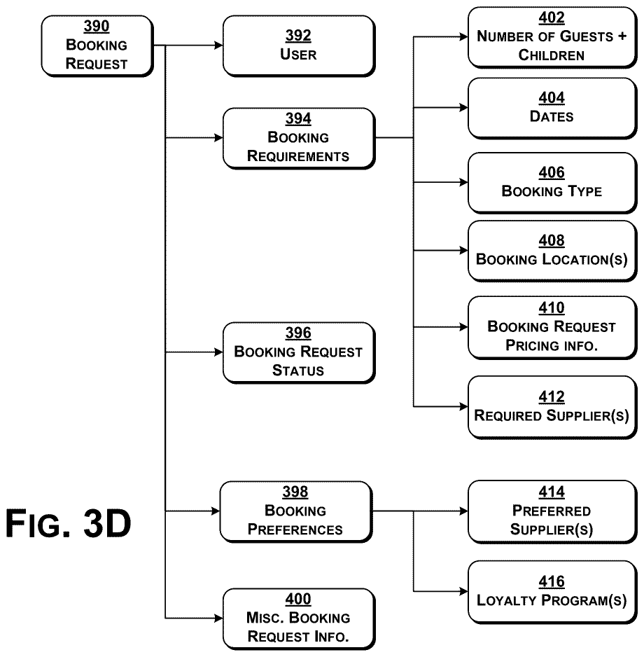

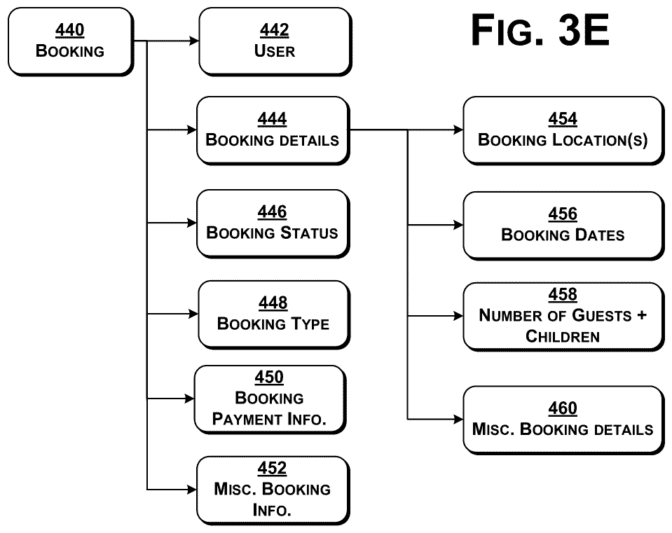

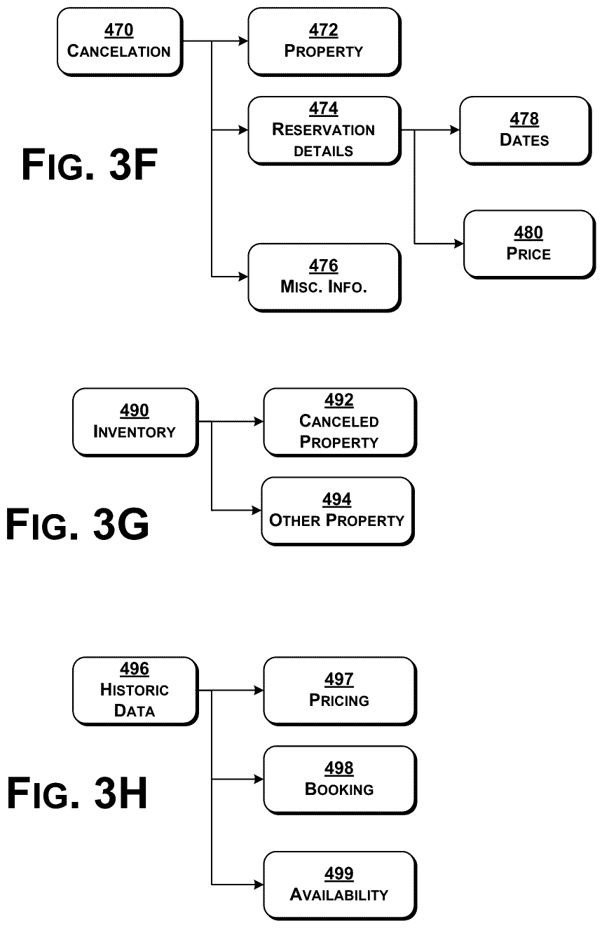

The system 102 may store and maintain information about properties in property database(s) 162. A property 302 in the property database(s) 162 may include some or all of the data shown in FIG. 3A, including property type 304, property name 306, property location 308, property description 310, room type(s) 312, pricing information 314, property ratings, reviews, etc. 316, property source(s) 318, property restrictions and requirements 320, property historical data 321, and other miscellaneous property information 322.

The property type 304 may encode the type of property (e.g., hotel, motel, flat, apartment, house, room, cabin, campsite, campground, building, tent, etc.).

The property name 306, if it has one, may be a name by which the property is known (e.g., a hotel name, a house name, an apartment building name, etc.).

The property location 308 may store or encode the property's location (e.g., GPS coordinates, a street or other address, etc.). In general, a property location 308 should correspond to a geographical (e.g., physical) location and provide a way for a user to locate and get to the property (e.g., by car, plane, boat, etc.).

The property description(s) 310 may include a narrative description 324, media 326 (e.g., photographs, videos, audio such as music, etc.), and/or website links 328.

If included, the property room type(s) 312 may describe the kinds of rooms the property provides (e.g., suite, king size, balcony, mountain view, etc.).

The property pricing information 314 may include rate information 330, cancelation policies 332, currency information 334, and other miscellaneous pricing information 336. The rate information 330 may depend, e.g., on the type of room, the duration of the rental, the purpose, whether the user has some loyalty or other status with the property (or with some other system), etc.

The property ratings, reviews, etc. 316, if any exist, may have been input by users of the system 102 and/or obtained from external sources (e.g., external systems and databases 112).

As used herein, a “supplier” refers to an entity through which a property may be reserved/booked. Suppliers may include, e.g., travel agents, travel booking websites, property owners or operators, etc. Information about suppliers may be stored in the supplier database(s) 166.

The property source(s) 318 may include information about sources through which the booking system 102 can book the property. A particular property may already be in the booking system's inventory (e.g., stored in inventory database(s) 164), e.g., through a booking cancelation. A property may also (or instead) be bookable through one or more suppliers (information about suppliers may be maintained and stored in the supplier database(s) 166, discussed below with reference to FIG. 3B).

The property's restrictions and requirements 320, if any exist, may include use restrictions 338, seasonal/holiday restrictions 340, age restrictions 342, duration of stay restrictions 344, and other miscellaneous restrictions or requirements 346.

With reference to FIG. 3B, the supplier database(s) 166 may maintain and store information about suppliers. For a particular supplier 350, the supplier database(s) 166 may include supplier details 352 (e.g., name, contact information, etc.), a list of supplier properties 354, supplier pricing information 356, and other miscellaneous supplier information 358. A particular property may be available through more than one supplier.

With reference to FIG. 3C, the user database(s) 160 may maintain and store information about users 104 (which, as noted above, may include influencers 108 and booking users 110). Since a booking user 110 may also be an influencer 108 (or vice versa), the user data 360 of a user 104 may include some information that is specific to the kind of user. Users may register with the system 102, and for a particular user 360, the data may include account information 362. Account information may include a user's biographical information (e.g., name, address, age, etc.), billing information (e.g., credit card details, etc.), and banking information (e.g., to allow rewards to be paid to the user, as described herein).

The data for a particular user 360 may also include the user history 364, which may include the user's prior booking requests 366 (if any) and the user's prior and current bookings 368 (if any).

If the particular user 360 is also an influencer, then the user information 360 may include that user's influencer information 370, which may include information about the user's media 372, information about the influencer user's rewards 374, and other miscellaneous influencer information 376.

The information about the user's (influencer's) media 372 may include media links 378, media information 380, and other miscellaneous information 382. The media links may be, e.g., a URL or the like, and may be associated with one or more properties. The media links 378 preferably link to media stored in media database(s) 174.

The data for a particular user 360 may include other miscellaneous user information 384.

As described below, users 104 (booking users 110) may access the system 102 to search for and book a property. The system 102 maintains and stores information about users' search/booking requests in the booking requests database(s) 170. With reference to FIG. 3D, a particular booking request 390 (corresponding to booking request(s) 366 in the user data 360) may include some or all of the following:
(a) user data 392 (which corresponds to data about the user (360) in the user database(s) 160, e.g., as described above with reference to FIG. 3C);
(b) user booking requirements 394;
(c) the booking request's status 396;
(d) booking preferences 398; and
(e) miscellaneous other booking request information 400.

The user booking requirements 394 may include, e.g., the number of guests (including the number of children) 402, the desired dates for the booking 404, the booking type 406, the desired booking location(s) 408, the desired booking's pricing 410, and required suppliers 412. As should be appreciated, not every booking request will have all the requirements. Other requirements may also be included.

The user booking preferences 398 may include, e.g., information about the user's preferred suppliers 414 and information about the user's loyalty programs 416.

The system 102 maintains and stores information about users' bookings (reservations) in the bookings database(s) 172 (see FIG. 1). With reference to FIG. 3E, a particular booking 440 may include some or all of the following:
(a) User information 442 (which corresponds to data about the user in the user database(s) 160, e.g., as described above with reference to FIG. 3C);
(b) Booking details 444;
(c) Booking status 446;
(d) Booking type 448;
(e) Booking payment information 450; and
(f) Miscellaneous booking information 452.

The booking details 444 may include the booking location(s) 454, the booking dates 456, the number of guests/children 458, and other miscellaneous booking details 460.

### Cancelations

The booking system 102 may allow users to cancel reservations made through the booking system, even when the property is booked through an agent or the like, and even when the reservation is not refundable. The booking system 102 may require a fee (e.g., a premium) for such a cancelation. When such a property reservation is canceled, the booking system 102 may add the property to its inventory.

For example, if a user books a particular property through the booking system 102, and the booking system 102 obtains that property from an agent (e.g., a hotel chain or travel website or the like), the booking system 102 may offer some kind of refund protection, even if the user's booking (reservation) is not refundable. If the user then cancels the reservation, the booking system may maintain that property in its inventory for rental (until the reservation expires).

As should be appreciated, the term “non-refundable” refers to the policy of the property supplier. As described herein, if the user cancels the reservation, the booking system may maintain that property in its inventory for rental. Thus, even though the property supplier does not issue a refund, the booking system may be willing to issue a full or partial refund.

An exemplary system supporting the cancelation of non-refundable reservations is described in U.S. Patent Application No. 2017/0365016, filed Nov. 16, 2015 (also published as WO/2016/116786) the entire contents of which are hereby fully incorporated herein by reference for all purposes.

The system 102 maintains and stores information about canceled reservations in cancelation database(s) 168. With reference to FIG. 3F, a cancelation entry 470 in the cancelation database(s) 168 may include a property 472, reservation details 474, and other miscellaneous cancelation information for this reservation/property. The reservation details 474 may include information determined from the booking information 440 of the canceled reservation (e.g., the dates 478 for the original reservation, price information 480, and other information needed or useful to rent this property).

For example, if a reservation was for three days, from dates D1 to D2, and the price paid to the original agent was $P, the system may store the dates D1 and D2 in the dates fields 478, and the price ($P) in the price field. That information allows the booking system 102 to determine whether a canceled property can be provided in response to a subsequent search.

### Inventory

The system 102 maintains and stores information about inventory in the inventory database(s) 164 (see FIG. 1). As explained in greater detail below, the inventory comprises properties available for booking directly or indirectly through the booking system 102. The system's inventory may include properties from canceled reservations.

With reference to FIG. 3G, a particular inventory 490 may be a canceled property 492 or another property 494 rentable by the booking system 102.

### Historic Data

The system 102 maintains and stores historical information in the historical database(s) 180 (see FIG. 1). With reference to FIG. 3H, the historical information 496 may include historical pricing information 497, historic booking information 498, and historic availability information 499.

### Operation

Various aspects of the operation of an exemplary booking system 102 are described.

### User Registration

Users may register (and may be required to register) with the booking system 102. Booker users 110 may be able to search and even make bookings (reservations) without registering, but the system may require registration to access certain features.

Influencers 108 may be required to register with the system 102.

Registration may occur in a known manner, online via a webpage or an application (e.g., booking app 202 on a user's computing device 200, as shown in FIG. 2).

Upon registration, a user may provide identifying information (e.g., name, address, etc.) that may be useful or needed to make and store bookings/reservations. The user information may be maintained and stored in the user database(s) 160, e.g., in the account information 362 and/or other fields of the user data 360.

The user data 360 may include financial information (e.g., banking details, credit card details, and the like) stored in a known manner. For a user making a reservation or receiving a refund, the financial information may be used to make payments or receive refunds. For an influencer, the financial information may be used to obtain influencer rewards, as discussed herein.

Each registered user may have a unique user identifier within the system. The system may generate This unique user identifier when the user registers. The user database(s) 160 may be indexed based on the unique user identifiers.

### Influencer Operations

An influencer 108 is a user 104 who associates, in the system 100, media (e.g., one or more images, videos, web pages, music, audio, text, commentaries, etc., alone or in combination) with at least one property. The media may be stored in the system 100 (e.g., in media database(s) 174) and shared via a website, a social media platform, email, etc. The association between media and a particular property may be achieved, as described below, and shared using a link (e.g., a URL) that is associated with the media, where the link, when selected (e.g., clicked) by a user, directs that user to the booking system 102 in a manner that allows reservation of the particular property. Links provided to users for sharing may resolve to one or more servers hosted and/or operated by the booking system 102 (e.g., to server(s) 152).

FIG. 4 shows an example of a web page 500 with media 504 having an associated link 502. The media 504 may be stored in media database(s) 174, and the link 502 may be a URL or the like that resolves to one or more server(s) 152.

When an influencer 108 wants to associate a link with certain media, the influencer 108 may, e.g., via the influencer mechanism(s) 148, request a link from the system 102. The influencer 108 provides the system with the media or access to the media and may provide other information about the media (e.g., the location where the media was obtained). As described below, the system 102 may perform various checks on the media using, e.g., integrity mechanism(s) 141 before uploading and storing the media in media database(s) 174. As described below, the checks performed may include, e.g., copyright and ownership checks, and other checks). If the media provided by the user passes the systems integrity checks, the system 102 associates the media with the user and, using, e.g., linking mechanism(s) 140, the system 102 generates a link to be associated with that media and that influencer. The system 102 may then provide the link to the influencer, e.g., using the influencer mechanism(s) 148.

The link preferably includes a hostname or domain name that resolves (using DNS or the like) to one or more servers operated by the system (e.g., one or more servers implemented by server mechanism(s) 152).

The rest of the link (e.g., a URL) may encode information that the server mechanism(s) 152 may use to determine the media and user (influencer) associated with the link.

An exemplary URL may have the form:
http://hostname/pathinfo (URL1)
where “hostname” resolves, e.g., using DNS, to a server at the booking system 102, and where “pathinfo” includes information allowing the system 102 to determine the user (influencer) associated with the link.

The link (e.g., the URL) should have the following properties:
(1) When a user selects the link (e.g., in a browser or the like), information in or associated with the link causes the user (or the user's browser) to be directed to the booking system (e.g., the link resolves to a server of the booking system).
(2) The link encodes sufficient information for the booking system to determine, directly or otherwise, the identity of the user (influencer) associated with the link.

Information about the media and the link may be stored, e.g., in media 372 and the media links 378.

### EXAMPLES

### Example 1

An influencer (with unique user identifier A123) uploads an image and requests a link for an image. The image is associated with location L456. The booking system's server is reachable at “s1.booking.com”.

The integrity mechanism(s) 141 checks the image.

If the image passes the checks made by the integrity mechanism(s) 141, the system uploads and stores the image in the media database(s) 174 and forms an association between that image and the user A123 (e.g., in the user database(s) 160. The linking mechanism 140 then generates a line—e.g., a URL of the form:
http://s1.booking.com/pathinfo
where pathinfo encodes information for the booking system to determine, directly or otherwise, the user's identity (influencer A123) associated with the link.

### Example 2

The same as example 1, but where pathinfo also contains an encoding of the media (e.g., of the media's URL).

### End of Examples

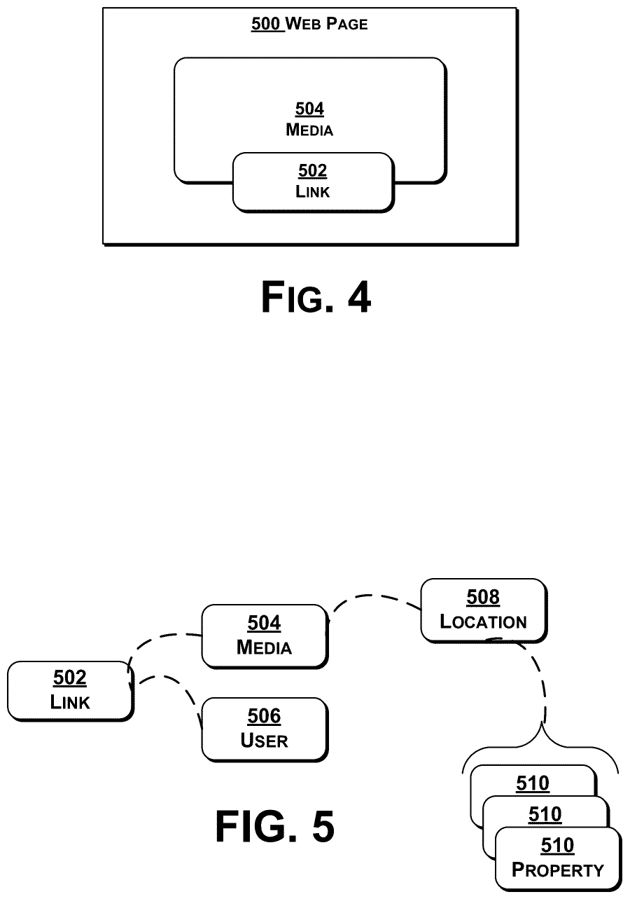

As shown in FIG. 5, the linking mechanism(s) 140 associates a link 502 with media 504 and the user/influencer 506 who uploaded the media. The media 504 is associated with location 508. The location 508 is associated with one or more properties 510. Media may be associated with multiple properties, e.g., when the media corresponds to a location such as a tourist attraction, etc., and the properties are properties at or near that location (e.g., hotels and the like near the tourist attraction).

The link 502 may also be (transitively) associated with each of those properties.

Thus, given a particular link 502, the system can determine the media 504 associated with that link, the location 508 associated with the media 504, and the one or more properties associated with that location 508. The system can also determine, from the link 502, the user 506 associated with the media (i.e., the user/influencer who added that media 504 to the system.

The system 102 maintains and stores information about the link and the corresponding media such that when someone selects that link, they may be directed (e.g., via the interaction and presentation mechanism(s) 142) to reservation information for a property associated with that media.

For example, if the media is associated with a particular tourist attraction (e.g., a beach), then someone selecting the link will be directed (e.g., via the interaction and presentation mechanism(s) 142) to a reservation or search mechanism for properties associated with that particular tourist attraction.

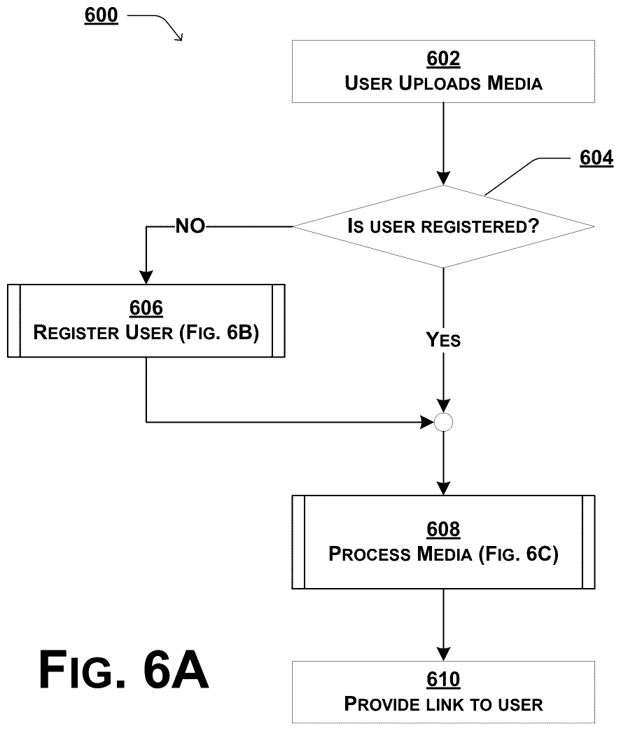

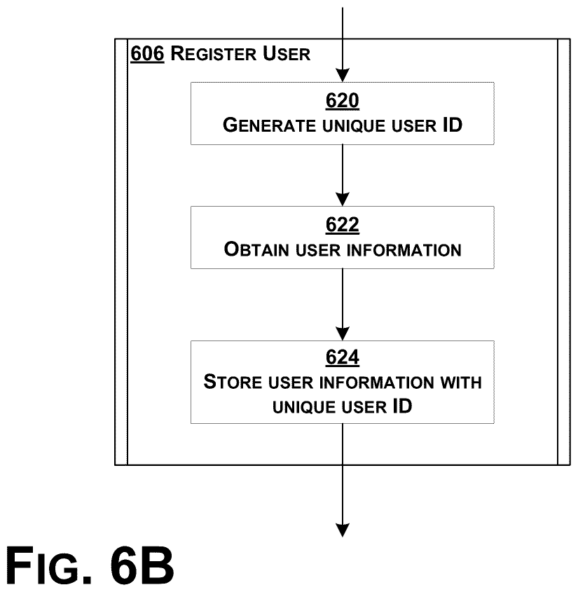

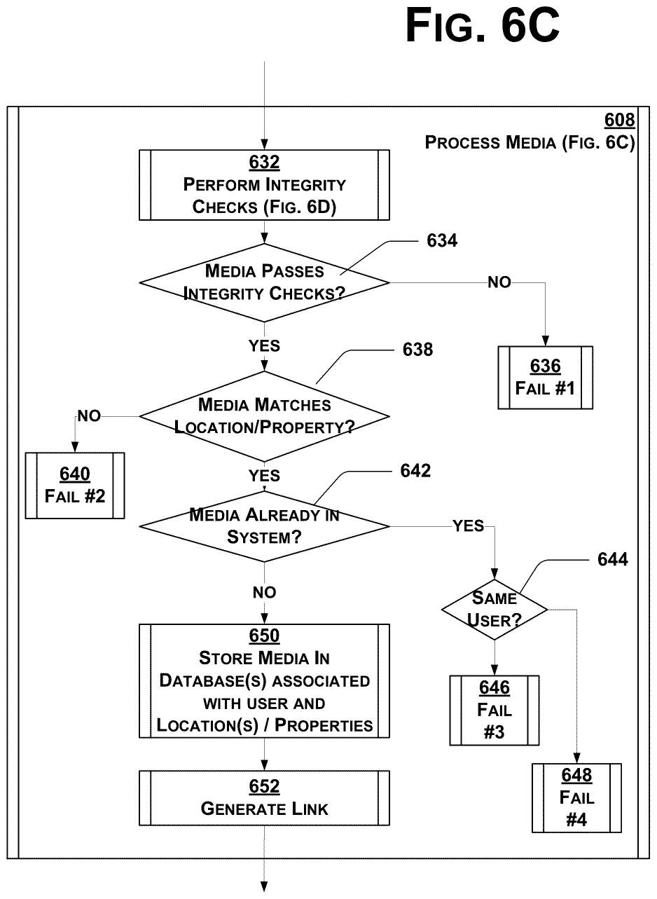

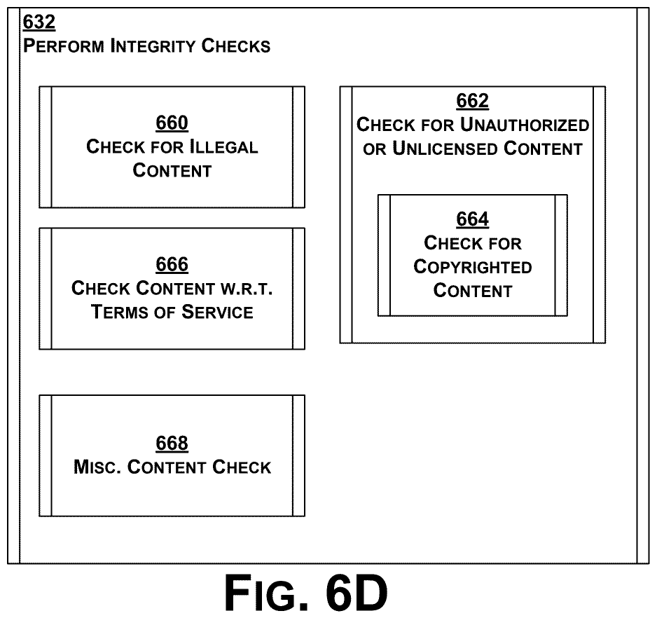

An exemplary process 600 of a user 104 (i.e., an influencer 108) uploading media (content) and obtaining a link is described with reference to the flowchart in FIG. 6A.

The user 104/108 accesses the influencer mechanism(s) 148 of booking system 102 via an appropriate application interface 190 and gateway/interface 192 and uploads media to the booking system 102 (at 602).

The influencer mechanism(s) 148 determines (at 604) whether the user is registered with the system. If the user is not registered with the system, the user is registered (at 606, see FIG. 6B), and then processing of the media continues (at 608). If the user is already registered (as determined at 604), then (at 608, see FIG. 6C), the system processes the media, as described below. If appropriate, a link associated with the media in the booking system is then provided to the user (at 610).

With reference to the flowchart in FIG. 6B, the process 606) of registering a user includes generating a unique user identifier (user ID) (at 620), obtaining user information (at 622), and storing the user information in the system, preferably keyed on or associated with the user ID (at 624). The user information may be stored, e.g., in the user database(s) 160.

The booking system's processing of uploaded media (in 608) is described with reference to the flowchart in FIG. 6C.

Embodiments of the booking system 102 will try to prevent the uploading and storing of unauthorized or illegal content. Accordingly, when media are first uploaded to the booking system 102, the system, e.g., using integrity mechanism(s) 141, performs various integrity checks (at 632, see FIG. 6D) to determine whether the media contains any unauthorized or illegal content. For example, content may be unauthorized, e.g., if it is copyrighted by someone other than the user doing the uploading or if it contains copyrighted audio (e.g., a music track). Content may be illegal if it contains content that is not legal in countries or locations where the system may be accessed or where the media may be stored.

With reference to FIG. 6D, the integrity checks performed (at 632) may include checking for illegal content (at 660) and checking for unauthorized and/or unlicensed content (at 662), which may include checking for copyrighted content (at 664). Checking for copyrighted content (at 664) may include checking for the audio (e.g., for copyrighted music).

The integrity checks performed (at 632) may also include checking that the content complies with the system's terms of service (at 666) and other miscellaneous content checks (at 668). While the integrity checks are preferably performed automatically (by computer), certain checks and conditions may trigger secondary checks that may be carried out by computer and/or human operators.

The integrity checks (at 632) may run in any order, including in parallel. However, for efficiency, the others may be terminated once any one check fails.

Outside services (e.g., via the external systems/database(s) 112) may perform some integrity checks.

In some implementations, the system may remove unauthorized or unlicensed content (e.g., copyrighted material found at 664) from media and still allow the remaining content to be uploaded. For example, if copyrighted music is found in the audio portion of a video, the system may allow the video to be uploaded without the copyrighted audio. In such cases, the user may be given the option of either allowing the media to be used without copyrighted content or terminating the upload.

If the integrity checks find illegal content (at 660), that may trigger secondary action by the system, as there may be reporting requirements for such content in certain jurisdictions.

If the media fails the integrity checks (as determined at 634), the upload will fail (fail #1 636) and the user may be notified of the failure and the reasons for failure. Otherwise, if the media passes the integrity checks (as determined at 634), processing continues with the system determining (at 638) whether the uploaded media corresponds to a location or property that the system books. The system may determine whether the media matches a location or property by using image analysis, obtaining location information from the media (e.g., GPS location information provided by a camera or phone and stored with the media), and/or by human analysis. A user may be able to provide so-called hashtags with the media, and those user-provided hashtags may be used to guide the determination and property match.

If the uploaded media does not match a location or property that is in the system (or handled by the system) (as determined at 638), then the upload will fail (Fail #2 640). The user may be notified of the failure and the reasons for the failure. In some embodiments, the system may still maintain a copy of the media associated with the user after such a failure. However, no link will be provided.

On the other hand, if the uploaded media matches a location or property that is in the system (or handled by the system) (as determined at 638), the system then determines (at 642) if the uploaded media is already in the system. This may occur, e.g., if a user has uploaded their own duplicate media or media that another user previously uploaded. The latter case may mean that one or both users have copied the media.

If it is determined (at 642) that the uploaded media is already in the system, the upload will fail. In this case, the system determines (at 644) whether the uploaded media is associated in the system with the same user (in which case the media is a duplicate upload by the same user). If the uploaded media is already in the system and associated with the same user (as determined at 644), then the upload will fail (Fail #3 646) and the user may be notified of the failure and the reasons for failure. If the uploaded media is already in the system and associated with a different user (as determined at 644), then the upload will fail (Fail #4 646) and the user may be notified of the failure and the reasons for failure. In the latter case, the user may be trying to upload someone else's content, and the system may process that user differently (e.g., they may be warned or blocked from the system).

If it is determined (at 642) that the uploaded media is not already in the system, then (at 650) the uploaded media are stored in a database (e.g., media database(s) 174) and associated with the user and with the location(s) and/or properties.

The system then generates a link (at 652) to be provided to the user (at 610 in FIG. 6A).

The link is preferably a URL, as described above, that resolves to a hostname associated with the booking system 102 (e.g., to server 152).

### Link Selection and Reservations

As described above, an influencer user may include a link (generated as described above) with certain media (e.g., by including the like-a URL on the same webpage as the media).

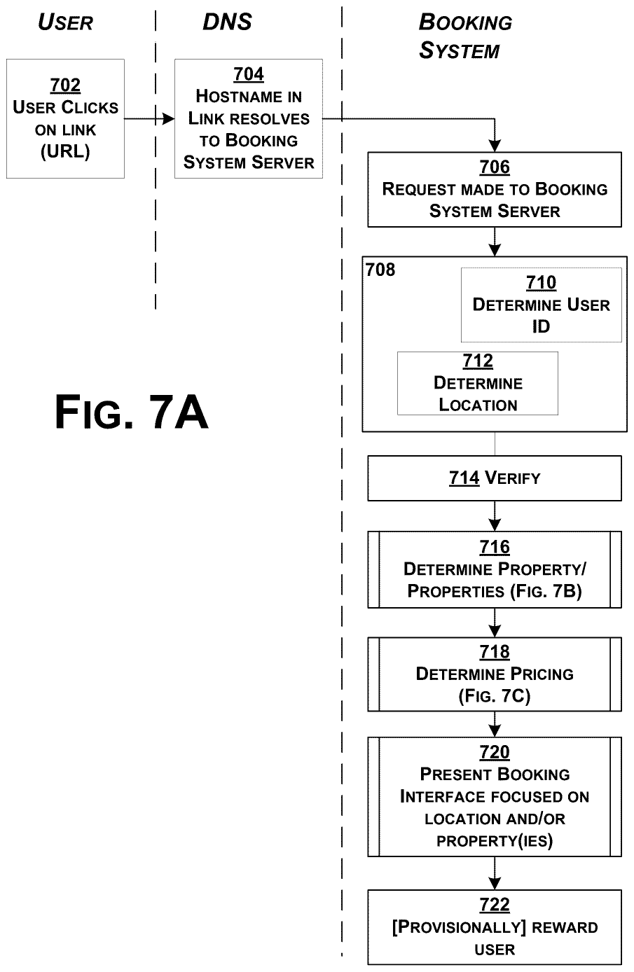

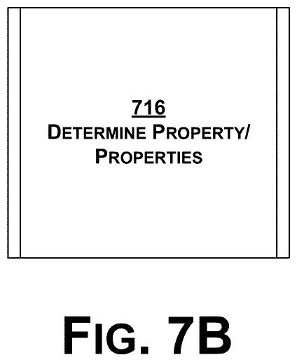

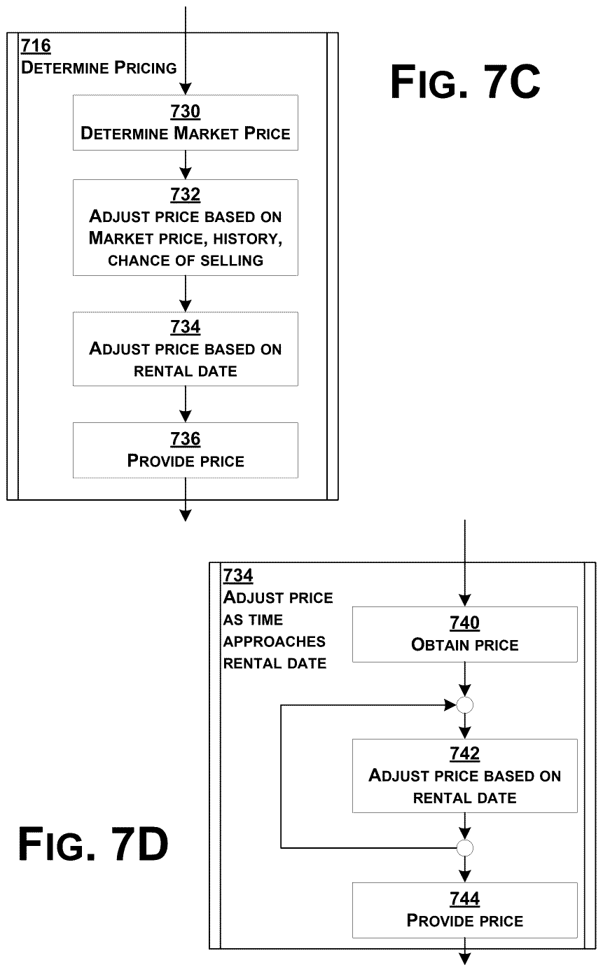

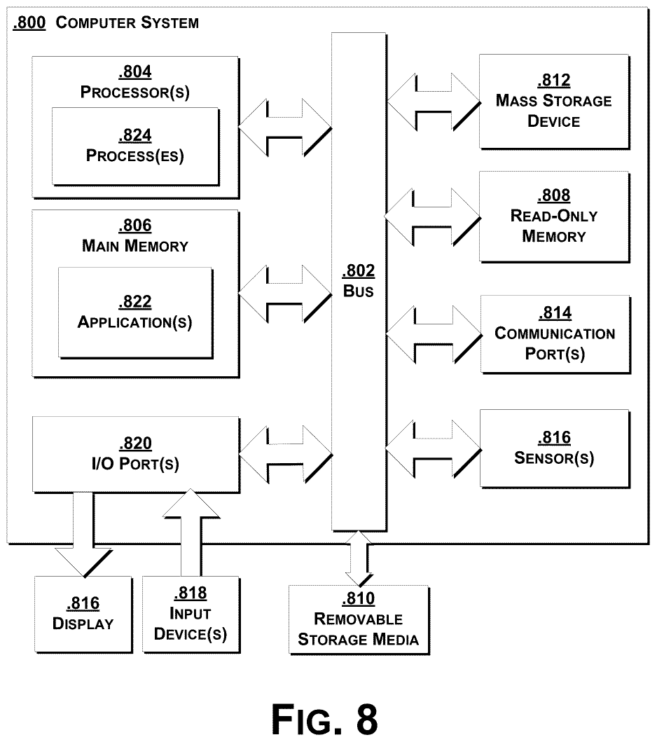

With reference to the flowchart in FIG. 7A, when a user selects (clicks on) a link (e.g., of the form http://s1.booking.com/pathinfo) (at 702) in their browser or an application, the name resolution system (e.g., the DNS system) resolves the hostname in that link (e.g., s1.booking.com) to a booking system server (at 704). The user's browser then makes a request (e.g., an HTTP request) to that server using the hostname and other information in the link.

As is known, an HTTP request may provide the hostname and pathinfo in HTTP headers.

The booking system server (e.g., server mechanism(s) 152) receives the request (at 706) and determines information from the request (e.g., from the request headers).

The booking system server (server mechanism(s) 152) may (at 708) determine information from or associated with the link, such as the user ID associated with the link (at 710) and location information (at 712).

The booking system may verify the user ID and other aspects of the link (at 714).

Assuming that the user ID and other aspects of the link are verified, the booking system may then determine (at 716, FIG. 7B) one or more properties associated with the link. It may then (at 718, FIGS. 7C, 7D) determine pricing for those properties.

Since the link is associated with media associated with a location (as determined at 712) (at 716), a list of bookable properties may be provided for that location. With reference to FIGS. 7A-7B, system 102 may determine appropriate properties (at 716) using the properties in the inventory database(s) 164 (which may include properties in the cancelation database(s) 168). The list of bookable properties may also include properties from external systems/database(s) 112 (e.g., other online booking sites, travel agents, hotel chains, etc.).

The properties and corresponding prices are presented to the user (at 720), e.g., using presentation mechanism(s) 146.

If the user books a property from this list, the influencer associated with the link (i.e., with a user ID from the link) is provisionally rewarded for the booking. In some cases, a reward may be provisional until the booking has been used, after which the influencer is credited with the booking. The influencer will preferably not be rewarded for a canceled booking.

### Determine Pricing—Dynamic Pricing

With reference to the flowchart in FIG. 7C, system 102, using, e.g., the pricing mechanism(s) 136, may dynamically determine prices for one or more properties (at 716).

For a particular property, the pricing mechanism(s) 136 may begin (at 730) determining the market price for that property, e.g., from other sites (using external systems/database(s) 112). The pricing mechanism(s) 136 may then (at 732) adjust the property price (preferably downward) based, at least in part, on (i) the market price (as determined at 730), (ii) the chance of selling the property, and/or (iii) rental and pricing history of that property. The rental and pricing history of a property may be obtained, e.g., from the database(s) 116, including the historical database(s) 180.

The chance of selling a property may be based, at least in part, on factors such as the property's location, expected weather during the rental period, and expected demand during the rental period. For example, a hotel room in New York City is likely to be rented during the Xmas period, whereas a beachfront property may be unlikely to be rented during winter.

The price may be adjusted (at 734) based on the rental date, and then the price is provided (at 736).

Once a price has been determined (at 716), that price may be provided to the user and stored in the property database(s) 162 (e.g., as pricing rates 330 associated with the particular property).

With reference to the flowchart in FIG. 7D, the system may adjust the price for a property (at 734) as time approaches the property's rental date. The pricing mechanism(s) 136 may obtain a price (e.g., using the process 716 described above with reference to FIG. 7C). The price may then be lowered (at 742, e.g., by fixed percentage increments), and then the modified (e.g., lower price) may be provided (at 744) and associated with the property.

If the property previously matched a user's search (at 716, FIG. 7A), the system may notify the user of the property's new (lower) price.

### Determining the Refund/Cancelation Fee

As described above, the booking system 102 may offer refund protection, even if the user's booking (reservation) is not refundable. This option may allow users to cancel reservations made through the booking system, even when the property is booked through an agent or the like, and even when the reservation is not refundable. The booking system 102 may require a refund/cancelation fee (e.g., a premium) for such a cancelation and refund. If the user then cancels the reservation, a portion of the user's payment may be refunded, and the booking system may maintain that property in its inventory for rental (until the reservation expires).

As should be appreciated, the term “non-refundable” refers to the policy of the property supplier. If the user cancels the reservation, the booking system may maintain that property in its inventory for rental. Thus, even though the property supplier does not issue a refund, the booking system may be willing to issue a partial refund.

An exemplary system supporting the cancelation of non-refundable reservations is described in U.S. Patent Application No. 2017/0365016, filed Nov. 16, 2015 (also published as WO/2016/116786) the entire contents of which are hereby fully incorporated herein by reference for all purposes.

As shown in FIG. 7A, once the system determines properties matching a user's search/request (at 716, FIG. 7B) and pricing for those properties (at 718, FIG. 7C), the system presents those properties and prices to the user. For at least some of those properties, the user may also be presented with a refund/cancelation option and a refund/cancelation fee. This option, if exercised, may refund a percentage of the price paid by the user, even for a non-refundable property.

In some implementations, the refund/cancelation option may only be offered to registered users or users who have paid a membership fee.

In presently preferred implementations, the booking system 100 (e.g., the pricing mechanism(s) 136) may determine a refund policy and corresponding refund/cancelation fee. The policy and/or fee may be determined dynamically, preferably at the time of booking.

Factors included in determining the refund/cancelation fee and/or policy may include one or more of the following:
(n) The property's price (e.g., the room, villa, etc.). This price may be determined using the dynamic pricing mechanism described above.
(o) Time (e.g., in days) to the check-in.
(p) The length of the stay.
(q) The probability of reselling the room.
(r) The probability and/or rate of activation.
(s) The price and/or rate of resale.
(t) A desired profit margin for the booking system.
(u) Amounts to be paid to partners.
(v) The refund percentage and/or amount.
(w) The location of the property.
(x) The date(s) for the stay (e.g., is it a holiday, a weekend, around an event).
(y) The number of guests (e.g., is it a single hotel room for 1 or 2 people or is it a villa sleeping 20 people)
(z) When/how the reservation was purchased.

As should be appreciated, some factors may be subsumed into others. For example, factors (l), (m), and (t)-(v) may relate to the probability of reselling the room.

Appendix A (which is considered part of this application for all purposes) includes exemplary source code to determine a refund/cancelation fee for a particular reservation.

### Real-Time

Those of ordinary skill in the art will realize and understand, upon reading this description, that, as used herein, the term “real-time” means near real-time or sufficiently real-time. It should be appreciated that there are inherent delays in electronic components and network-based communication (e.g., based on network traffic and distances), which may cause delays in data reaching various components. Inherent delays in the system do not change the real-time nature of the data. In some cases, the term “real-time data” may refer to data obtained in sufficient time to make the data useful for its intended purpose.

Although the term “real-time” may be used here, it should be appreciated that the system is not limited by this term or by how much time is actually taken. In some cases, a real-time computation may refer to an online computation, i.e., a computation that produces its answer(s) as data arrive and generally keeps up with continuously arriving data. The term “online” computation is compared to an “offline” or “batch” computation.

### Computing

The applications, services, mechanisms, operations, and acts shown and described above are implemented, at least in part, by software running on one or more computers.

Programs that implement such methods (as well as other types of data) may be stored and transmitted using various media (e.g., computer-readable media) in several manners. Hard-wired circuitry or custom hardware may be used in place of, or in combination with, some or all of the software instructions that can implement the processes of various embodiments. Thus, various combinations of hardware and software may be used instead of software only.

One of ordinary skill in the art will readily appreciate and understand, upon reading this description, that the various processes described herein may be implemented by, e.g., appropriately programmed general-purpose computers, special-purpose computers, and computing devices. One or more such computers or computing devices may be referred to as a computer system.

FIG. 8 is a schematic diagram of a computer system 800 upon which embodiments of the present disclosure may be implemented and carried out.

According to the present example, the computer system 800 includes a bus 802 (i.e., interconnect), one or more processors 804, a main memory 806, read-only memory 808, removable storage media 810, mass storage 812, and one or more communications ports 814. Communication port(s) 814 may be connected to one or more networks (not shown) by which the computer system 800 may receive and/or transmit data.

As used herein, a “processor” means one or more microprocessors, central processing units (CPUs), computing devices, microcontrollers, digital signal processors, or like devices or any combination thereof, regardless of their architecture. An apparatus that performs a process can include, e.g., a processor and those devices such as input and output devices that are appropriate to perform the process.

Processor(s) 804 can be any known processor, such as but not limited to, an Intel® Itanium® or Itanium 2® processor(s), AMD® Opteron® or Athlon MP® processor(s), or Motorola® lines of processors, and the like. Communications port(s) 814 can be any Ethernet port, a Gigabit port using copper or fiber, a USB port, and the like. Communications port(s) 814 may be chosen depending on a network such as a Local Area Network (LAN), a Wide Area Network (WAN), or any network to which the computer system 800 connects. The computer system 800 may be in communication with peripheral devices (e.g., display screen 816, input device(s) 818) via Input/Output (I/O) port 820.

Main memory 806 can be Random Access Memory (RAM) or any other dynamic storage device(s) commonly known in the art. Read-only memory (ROM) 808 can be any static storage device(s), such as Programmable Read-Only Memory (PROM) chips for storing static information, such as instructions for processor(s) 804. Mass storage 812 can be used to store information and instructions. For example, hard disk drives, an optical disc, an array of disks such as a Redundant Array of Independent Disks (RAID), or any other mass storage devices may be used.

Bus 802 communicatively couples processor(s) 804 with the other memory, storage, and communications blocks. Bus 802 can be a PCI/PCI-X, SCSI, a Universal Serial Bus (USB) based system bus (or other) depending on the storage devices used, and the like. Removable storage media 810 can be any kind of external storage, including hard-drives, floppy drives, USB drives, Compact Disc-Read Only Memory (CD-ROM), Compact Disc-Re-Writable (CD-RW), Digital Versatile Disk-Read Only Memory (DVD-ROM), etc.

Embodiments herein may be provided as one or more computer program products, which may include a machine-readable medium having stored thereon instructions, which may be used to program a computer (or other electronic devices) to perform a process. As used herein, the term “machine-readable medium” refers to any medium, a plurality of the same, or a combination of different media, which participate in providing data (e.g., instructions, data structures) that may be read by a computer, a processor or a like device. Such a medium may take many forms, including but not limited to non-volatile media, volatile media, and transmission media. Non-volatile media include, for example, optical or magnetic disks and other persistent memory. Volatile media include dynamic random-access memory, which typically constitutes the computer's main memory. Transmission media include coaxial cables, copper wire, and fiber optics, including the wires that comprise a system bus coupled to the processor. Transmission media may include or convey acoustic waves, light waves, and electromagnetic emissions, such as those generated during radio frequency (RF) and infrared (IR) data communications.

The machine-readable medium may include but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other types of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

Various forms of computer-readable media may be involved in carrying data (e.g., sequences of instructions) to a processor. For example, data may be (i) delivered from RAM to a processor; (ii) carried over a wireless transmission medium; (iii) formatted and/or transmitted according to numerous formats, standards, or protocols; and/or (iv) encrypted in any of a variety of ways well known in the art.

A computer-readable medium can store (in any appropriate format) those program elements that are appropriate to perform the methods.

As shown, main memory 806 is encoded with application(s) 822 that support(s) the functionality as discussed herein (the application(s) 822 may be an application(s) that provides some or all of the functionality of the services/mechanisms described herein). Application(s) 822 (and/or other resources as described herein) can be embodied as software code such as data and/or logic instructions (e.g., code stored in the memory or on another computer-readable medium such as a disk) that supports processing functionality according to different embodiments described herein.

During operation of an embodiment, processor(s) 804 accesses main memory 806 via bus 802 to launch, run, execute, interpret, or otherwise perform the logic instructions of the application(s) 822. Execution of application(s) 822 produces processing functionality of the service related to the application(s). In other words, the process(es) 824 represent one or more portions of the application(s) 822 performing within or upon the processor(s) 804 in the computer system 800.

It should be noted that in addition to the process(es) 824 that carries (carry) out operations as discussed herein, other embodiments herein include the application 822 itself (i.e., the un-executed or non-performing logic instructions and/or data). The application 822 may be stored on a computer-readable medium (e.g., a repository) such as a disk or an optical medium. According to other embodiments, the application 822 can also be stored in a memory type system such as in firmware, read-only memory (ROM), or, as in this example, as executable code within the main memory 806 (e.g., within Random Access Memory or RAM). For example, application(s) 822 may also be stored in removable storage media 810, read-only memory 808, and/or mass storage device 812.

Those skilled in the art will understand that the computer system 800 can include other processes and/or software and hardware components, such as an operating system that controls the allocation and use of hardware resources.

As discussed herein, embodiments of the present invention include various steps or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware. The term “module” refers to a self-contained functional component, which can include hardware, software, firmware, or any combination thereof.

One of ordinary skill in the art will readily appreciate and understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, can cause a processor to perform some (but not necessarily all) of the described process.

Where a process is described herein, those of ordinary skill in the art will appreciate that the process may operate without any user intervention. In another embodiment, the process includes some human intervention (e.g., a step is performed by or with the assistance of a human).

As used herein, including in the claims, the phrase “at least some” means “one or more” and includes the case of only one. Thus, e.g., the phrase “at least some ABCs” means “one or more ABCs” and includes the case of only one ABC.

As used herein, including in the claims, the term “at least one” should be understood as meaning “one or more,” and therefore includes both embodiments that include one or multiple components. Furthermore, dependent claims that refer to independent claims that describe features with “at least one” have the same meaning, both when the feature is referred to as “the” and “the at least one.”

As used herein, including in the claims, the term “portion” means some or all. So, for example, “A portion of X” may include some of “X” or all of “X.” In the context of a conversation, the term “portion” means some or all of the conversation.

As used herein, including in the claims, the phrase “based on” means “based in part on” or “based, at least in part, on” and is not exclusive. Thus, e.g., the phrase “based on factor X” means “based in part on factor X” or “based, at least in part, on factor X.” Unless stated explicitly by the use of the word “only,” the phrase “based on X” does not mean “based only on X.”

As used herein, including in the claims, the phrase “using” means “using at least” and is not exclusive. Thus, e.g., the phrase “using X” means “using at least X.” Unless expressly stated by the use of the word “only,” the phrase “using X” does not mean “using only X.”

In general, as used herein, including in the claims, unless the word “only” is specifically used in a phrase, it should not be read into that phrase.

As used herein, including in the claims, the phrase “distinct” means “at least partially distinct.” Unless expressly stated, distinct does not mean fully, wholly, or entirely distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

As used herein, including in the claims, the terms “multiple” and “plurality” mean “two or more” and include the case of “two.” Thus, e.g., the phrase “multiple ABCs” means “two or more ABCs” and includes “two ABCs.” Similarly, e.g., the phrase “multiple PQRs” means “two or more PQRs” and includes “two PQRs.”

As used herein, including in the claims, the term “automatic,” with respect to an action, generally means that the action occurs with little or no human control or interaction. The term “automatic” also includes the case of no human control or interaction. Thus, e.g., the term “triggered automatically” means “triggered with little or no human control or interaction” and includes the case “triggered with no human control or interaction.”

As used herein, including in the claims, singular forms of terms are to be construed as also including the plural form and vice versa unless the context indicates otherwise. Thus, it should be noted that as used herein, the singular forms “a,” “an,” and “the” include plural references unless the context clearly dictates otherwise.

Throughout the description and claims, the terms “comprise,” “including,” “having,” and “contain” and their variations should be understood as meaning “including but not limited to” and are not intended to exclude other components unless expressly so stated.

It will be appreciated that variations to the embodiments of the invention can be made while still falling within the scope of the invention. Alternative features serving the same, equivalent, or similar purpose can replace features disclosed in the specification unless stated otherwise. Thus, unless stated otherwise, each feature disclosed represents one example of a generic series of equivalent or similar features.

The present invention also covers the exact terms, features, values, and ranges, etc., in case these terms, features, values, and ranges, etc. are used in conjunction with terms such as about, around, generally, substantially, essentially, at least, etc. (i.e., “about 3” shall also cover exactly 3 or “substantially constant” shall also cover exactly constant).

Use of exemplary language, such as “for instance,” “such as,” “for example” (“e.g.,”), and the like, is merely intended to illustrate the invention better and does not indicate a limitation on the scope of the invention unless specifically so claimed.

Any acts described in the specification may be performed in any order or simultaneously unless the context clearly indicates otherwise.

All the features and/or acts disclosed herein can be combined in any combination, except for combinations where at least some of the features and/or acts are mutually exclusive. In particular, preferred features of the invention are applicable to all aspects of the invention and may be used in any combination.

It should be appreciated that the words “first” and “second” in the description and claims are used to distinguish or identify and not to show a serial or numerical limitation. Similarly, the use of letter or numerical labels (such as “(a),” “(b),” and the like) are used to help distinguish and/or identify and not to show any serial or numerical limitation or ordering.

Unless specifically shown and stated, no ordering is implied by any labeled boxes in flow diagrams. When disconnected boxes are shown in a diagram, the activities associated with those boxes may be performed in any order, including fully or partially in parallel.

Thus are provided systems and methods for delivering multimedia content to multiple participants at one or more physical locations.

While the invention has been described in connection with what is presently considered to be the most practical and preferred embodiments, it is to be understood that the invention is not to be limited to the disclosed embodiment but, on the contrary, is intended to cover various modifications and equivalent arrangements included within the spirit and scope of the appended claims.

Although certain presently preferred embodiments of the invention have been described herein, it will be apparent to those skilled in the art to which the invention pertains that variations and modifications of the described embodiments may be made without departing from the spirit and scope of the invention.

### APPENDIX A (SOURCE CODE)

Exemplary source code for determining the cancelation/refund fee (in the Ruby programming language):

```
# frozen_string_literal: true
require 'modules/partners'
module ProtectionFee
  class Calculate < ApplicationService
    include ::NewRelic::Agent::MethodTracer
    include Reportable
    def initialize(**args_hash,  &block)
      validate_arguments args_hash
      @price  =  args_hash [ :price_usd] .to_f
      @refund_percentages =  args_hash [ :refund_percentages ] .map
{ | x| x / 100.to_f  }
      @pos  =  args_hash [ :point_of_sale] .presence  | | ' unknown '
      @fee_partner_share  =  fee_partner_share_percentage
      @enable_audit  =  args_hash [ :enable_audit ]
      @audit_data  =  args_hash
      @predicate_key =  ″#{args_hash [ :offer_id] }.″  if
args_hash [ :offer_id] .present?
      @length_of_stay  =  if  args_hash [ :check_out] .present?  & &
args_hash [ :check_in ] .present?
                        (args_hash [ :check_out] .to_date -
args_hash [ :check_in] .to_date) .to_i
                        end
      @cached  =  true
      @block  =  block
      location args_hash [ :hotel_city], args_hash [ :hotel_state],
args_hash [ :hotel_country]
      @lead time bucket  =  lead time bucket
args_hash [ :days_to_check_in]
    end
    def call
      min_fee, max_fee = LifeHappensRate.min_max_rates_usd
partner_id: Partner.current_partner.id,
price_usd:  @price,
location_id:  @location_id
      fee_cache_key  =  [ 'fee-pct/par' ,
Partner.current_partner.id, 'pos',  @pos,
                        'loc', @location_id.presence
@loc_ctry_code,  'bck',  @lead_time_bucket,
                        'nights',  @length_of_stay] .join( '/' )
      report_to_librato( 'fee.calculate.all' ,
Partner.current_partner&.name)
      hash  =  APPLICATION_CACHE.fetch(key:  fee_cache_key,  ttl:
'default' )  do
      report_to_librato( 'fee.calculate.no_cache' ,
Partner.current_partner&.name)
      @cached  =  false
      @final_resale_percentage  =  resale_percentage
      @final_refund_percentage  =  refund_percentage
      fee_pct_hash  =  { }
      @final_refund percentage. each_pair do  |refund_pct,
value |
        fee_pct_has [ refund_pct ]  =
( ( @final_resale_percentage - value) .abs  /  (1  -  roomer_margin) )
/ (1  -  @fee_partner_share)
        end
        {
          fee_pct:  fee_pct_hash,
          final_resale_pct:  @final_resale_percentage,
          final_refund_pct:  @final_refund_percentage
        }
      end
      hash [ :fee_pct ] .each_pair do  |refund_pct, fee_pct|
        next if fee_pct.nil? | | fee pct == Float::INFINITY
        refund_rate_key  =  (refund_pct * 100) .to_i
        hash [ :calculated_fee] | | =  { }
        hash [ :calculated_fee] [refund_rate_key] = [min_fee,
fee_pct * @price] .max
      end
      if save_audits?
        SaveForAudit.call from_cache:  @cached,
                        token:  @audit_data [ :token ],
                        check_in:  @audit_data [ :check_in],
                        days_to_check in:
@audit_data [ :days_to_check_in],
                        percentile:  @lead_time_bucket,
                        price:  @price,
                        fee_in_usd: fee_from_settings | |
                        default_fee,
                        profitable_fee:
hash [ :calculated_fee] .values.first,
                        profitable_fee_percentage:
hash [ :fee_pct] .keys.first,
                        refund_amount:  refund_amount,
                        point_of_sale:  @pos,
                        location_id:  @location_id,
                        activation_rate:
activation_probability,
                        resale_rate:  resale_probability,
                        resale_coefficient_nights:
resale_coefficient_nights,
                        resale_coefficient_partner:
resale_coefficient_partner,
                        total_resale_coefficient:
resale_coefficient,
                        final_resale_percentage:
@final_resale_percentage,
                        final_refund_percentage:
@final_refund_percentage,
                        hotel_city:  @audit_data [ :hotel_city],
                        hotel_state:
@audit_data [ :hotel_state],
                        hotel_country:
@audit_data [ :hotel_country]
    end
    @block.call hash, max_fee
  rescue StandardError  =>  e
    Rollbar.error ( 'An exception in fee calculation service',
e)
    @block.call [min_fee, fee_from_settings
default_fee] .max, max_fee
  end
  private
  def_save_audits?
    return false if ENV[ ' DISABLE_FLEX_FEE_AUDIT' ] .present?
&& ENV[ ' DISABLE_FLEX_FEE_AUDIT' ] .to_i.positive?
    @enable_audit  !=  false
  end
  def_validate_arguments( hash )
    parameters  =  %i [refund_percentages days_to_check_in]
    valid  =  parameters.all?  { | name | hash [ name ]  }
    valid  &&=  Partner.current_partner.present?
    raise ArgumentError, 'some of required arguments are not
found'  unless  valid
  end
  def fee_partner_share_percentage
    share  =  Partner.current_partner&.lh_rev_share.to_f  /  100
    return 0.2 if roomer travel?  &&  share.zero?
    share
  end
    def_location(city,  state,  country)
    state  =  state.presence | | 'xxx'
    @location_id  =
RoomerFlex::LocationMapping.by_city_state_country city, state,
country
    @loc_ctry_code  =
RoomerFlex::LocationMapping.country_code country_name:  country
  end
  def  lead_time_bucket( days )
    LeadTimeBucket.by_partner_and_days
Partner.current_partner.id,  days
  end
  def activation_probability
    if defined?  @activation_probability
      return  @activation_probability
    end
    @activation_probability  =  ActivationRate.percentage
partner_id:  Partner.current_partner.id,
location_id:  @location_id,
point_of_sale:  @pos,
days _to_check_in_percentile:  @lead_time_bucket
        @activation_probability
  end
  def resale_probability
    return @resale probability if defined?
@resale_probability
    @resale_probability  =  ResaleRate.percentage (pid:
Partner.current_partner.id,
                            lid:  @location_id,
                  ctry:  @loc_ctry_code)
    @resale probability | | =
DynamicFeeConfig.default_resale_percentage
        @resale_probability
  end
  def refund_percentage
    if defined?  @refund_pct
      return  @refund_pct
    end
    @refund_coefficients_hash  =  { }
    @refund_pct  =  @refund_percentages.each_with_object( { } )
do  |pct,  h|
      @refund_coefficients_hash [pct]  =
DynamicFeeConfig.refund_coefficient(@lead_time_bucket,  pct)
    h[pct]  =  (activation_probability  /  100.to_f)  *  pct *
@refund_coefficients_hash[pct]
    end
    @refund_pct
  end
  def resale_percentage
    if defined?  @resale_percentage
      return  @resale_percentage
    end
    @resale_percentage  =  resale_coefficient  *
(activation_probability.to_f  /  100)  *  (resale_probability.to_f
/  100)
    @resale percentage
  end
  #  factor
  def resale_coefficient
    if defined?  @resale_coefficient
      return @resale_coefficient
    end
    @resale_coefficient  =  resale_coefficient_nights  +
resale_coefficient_partner
    @resale coefficient
  end
  def roomer_margin
    DynamicFeeConfig.margin
  end
def fee_from_settings
    return  @fee_from_settings if defined? @fee_from_settings
    value  =  LifeHappensRate.fee_percentage_by partner_id:
Partner.current_partner.id
    @fee_from_settings  =  value. zero? ? nil  :  value * @price
  end
  def default_fee
    (LifeHappensRate.default_rates[ :fee].to_f / 100 ) *
@price
  end
  def refund amount
    LifeHappensRate.refund_amount partner_id:
Partner.current_partner.id,  price_usd: @price
  end
  def roomer_travel?
    Partner. current partner. id == ::Partners::ROOMER_TRAVEL
  end
  def resale_coefficient_nights
    return  @resale_coefficient_nights if defined?
@resale_coefficient_nights
    if DynamicFeeConfig.resale_by_length_of_stay_weight  +
DynamicFeeConfig.resale_by_partner_weight  >  1
      weight  =  1  −  DynamicFeeConfig.resale_by_partner_weight
    end
    weight | | =
DynamicFeeConfig.resale_by_length_of_stay_weight
    @resale_coefficient_nights  =  weight  *
ResaleRate.by_length_of_stay ( nights:  @length_of_stay)
    @resale_coefficient_nights =
@resale_coefficient_nights.to_f.round( 5 )
  end
  def resale_coefficient_partner
    if defined?  @resale_coefficient_partner
      return @resale_coefficient_partner
    end
    resale_rate_per_partner  =  ResaleRate.by_partner(id:
Partner.current_partner.id)
    @resale_coefficient_partner  =
      DynamicFeeConfig.resale_by_partner_weight *
resale_rate_per_partner
    @resale_coefficient_partner.to_f.round ( 5 )
  end
add_method_tracer :resale_coefficient#{@predicate_key}dynamic_
fee.
  add_method_tracer :resale_coefficient_nights
  add_method_tracer :resale_coefficient_partner
  add_method_tracer :initialize
  add_method_tracer :call
  add_method_tracer :location
  end
end
```

1. A computer-implemented method in a framework comprising a booking platform having one or more computer systems storing information in one or more databases,
the method comprising:
(A)(1) obtaining media from a first user;
(A)(2) verifying the media obtained in (A), and, based on the verifying, when the media fails the verifying, terminating, otherwise,
(B)(1) forming and maintaining:
(i) a first association between the first user and the media; and
(ii) a second association between the media and a location;
(B)(2) determining a link for the media, wherein the link encodes information for the booking platform to determine, directly or indirectly, an identity of the first user;
(B)(3) maintaining:
(iii) a third association between the first user and the link; and
(iv) a fourth association between the link and the media;
(B)(4) providing the link to the first user;
(C)(1) in response to a second user selecting the link, where the link was presented to the second user in combination with the media, directing the second user to a server associated with the booking platform, the server presenting the second user with information about one or more properties at the location, wherein the one or more properties are selected from (i) properties in an inventory of the framework and/or (ii) properties from one or more external suppliers, and wherein the framework maintains a list of canceled-and-still-usable reservations and wherein the one or more properties comprise one or more canceled-and-still-usable reservations; and
(C)(2) in response to the second user making a reservation for a particular property of the one or more properties, provisionally rewarding the first user with a provisional reward, wherein the provisional reward is unredeemable until the reservation is used,
wherein the information about one or more properties at the location comprises pricing information for the one or more properties, and
wherein pricing information for the one or more properties comprises dynamic pricing information for the one or more properties, and
wherein the dynamic pricing information was determined after the second user selected the link, and in response to the second user selecting the link,
wherein, for at least some of the one or more properties at the location, the information includes a corresponding refund option, including a refund amount and a refund fee, wherein a particular refund option for a particular property was determined after the second user selected the link and in response to the second user selecting the link.

2. The computer-implemented method of claim 1, further comprising:
(D) in response to the reservation being used, converting the provisional reward to a redeemable reward.

3. The computer-implemented method of claim 1, wherein the verifying in (A)(2) comprises one or more of:
(i) checking the media for illegal content; and/or
(ii) checking the media for unauthorized or unlicensed content; and/or
(iii) checking whether the media violates terms of service of the booking platform; and/or
(iv) checking whether the media is already stored in the booking platform; and/or
(v) checking whether the media is from the location or was acquired at the location.

4-5. (canceled)

6. The computer-implemented method of claim 1, wherein, for a particular property of the one or more properties, the dynamic pricing information was determined based on one or more of: (i) a market price of the particular property, (ii) a chance of selling the particular property, and/or (iii) rental and pricing history of the particular property.

7-11. (canceled)

12. The computer-implemented method of claim 1, wherein the refund fee for the particular property was determined based on one or more of:
(a) a price for the particular property, wherein the price was determined after the second user selected the link; and/or
(b) time to check-in; and/or
(c) a length of stay associated with the particular property; and/or
(d) a probability of reselling the particular property; and/or
(e) a probability and/or rate of activation for the particular property; and/or
(f) an expected price and/or rate of resale of the particular property; and/or
(g) a desired profit margin; and/or
(h) location of the particular property; and/or
(i) amounts to be paid to partners; and/or
(j) the refund amount; and/or
(k) dates for the stay; and/or
(l) a number of guests the particular property can accommodate; and/or
(m) when or how the reservation was purchased.

13. (canceled)

14. The computer-implemented method of claim 1, wherein the media comprises one or more photographs, images, videos, web pages, music, audio, text, commentaries, and/or graphics, alone or in combination.

15. The computer-implemented method of claim 1, wherein the one or more properties are selected from: hotels, motels, flats, apartments, houses, rooms, cabins, camping sites, campgrounds, buildings, and tents.

16-17. (canceled)

18. The computer-implemented method of claim 1, wherein the one or more external suppliers are selected from travel agents, travel booking websites, and property owners or operators.

19. The computer-implemented method of claim 1, wherein the provisional reward for a particular property is based on a price for the particular property.

20. The computer-implemented method of claim 1, wherein a redeemable reward is based on a price actually paid for the particular property.

21. The computer-implemented method of claim 1, where dynamic property pricing information and/or dynamic refund option pricing are performed in real-time in response to a user selecting the link.

22. (canceled)

23. The computer-implemented method of claim 1, wherein the link is in the media.

24-40. (canceled)

41. An article of manufacture comprising non-transitory computer-readable media having computer-readable instructions stored thereon, the computer-readable instructions including instructions for implementing a computer-implemented method, the computer-implemented method operable on a device comprising hardware including memory and at least one processor and running a service on the hardware, the method comprising the computer-implemented method of claim 1.

42. A system comprising
one or more processors; and
one or more memories storing one or more programs configured to be executed by the one or more processors, the one or more programs including instructions for performing the method of claim 1.

43. A device comprising:
one or more memories; and
one or more processors executing program instructions stored in the one or more memories and being configured to perform the method of claim 1.

44. A non-transitory computer-readable medium with one or more computer programs stored therein that, when executed by one or more processors, cause the one or more processors to perform at least the operations of the method of claim 1.

45. A computer-implemented method in a framework comprising a booking platform having one or more computer systems storing information in one or more databases,
the method comprising:
(A)(1) obtaining media from a first user;
(A)(2) verifying the media obtained in (A), and, based on the verifying, when the media fails the verifying, terminating, otherwise,
(B)(1) forming and maintaining:
(i) a first association between the first user and the media; and
(ii) a second association between the media and a location;
(B)(2) determining a link for the media, wherein the link encodes information for the booking platform to determine, directly or indirectly, an identity of the first user;
(B)(3) maintaining:
(iii) a third association between the first user and the link; and
(iv) a fourth association between the link and the media;
(B)(4) providing the link to the first user;
(C)(1) in response to a second user selecting the link, where the link was presented to the second user in combination with the media, directing the second user to a server associated with the booking platform, the server presenting the second user with information about one or more properties at the location, wherein the one or more properties are selected from (i) properties in an inventory of the framework and/or (ii) properties from one or more external suppliers, wherein the framework maintains a list of canceled-and-still-usable reservations and wherein the one or more properties comprise one or more canceled-and-still-usable reservations;
(C)(2) in response to the second user making a reservation for a particular property of the one or more properties, provisionally rewarding the first user with a provisional reward, wherein the provisional reward is unredeemable until the reservation is used; and
(D) in response to the reservation being used, converting the provisional reward to a redeemable reward,
wherein the information about one or more properties at the location comprises pricing information for the one or more properties, and
wherein pricing information for the one or more properties comprises dynamic pricing information for the one or more properties, wherein, for a particular property of the one or more properties, the dynamic pricing information was determined based on one or more of: (i) a market price of the particular property, (ii) a chance of selling the particular property, and/or (iii) rental and pricing history of the particular property, and
wherein the dynamic pricing information was determined in real-time after the second user selected the link, and in response to the second user selecting the link,
wherein, for at least some of the one or more properties at the location, the information includes a corresponding refund option, including a refund amount and a refund fee, wherein a particular refund option for a particular property was determined in real-time after the second user selected the link, and in response to the second user selecting the link,
wherein the provisional reward for a particular property is based on a price for the particular property, and wherein a redeemable reward is based on a price actually paid for the particular property,
wherein the media comprises one or more photographs, images, videos, web pages, music, audio, text, commentaries, and/or graphics, alone or in combination.

46. The computer-implemented method of claim 45, wherein the verifying in (A)(2) comprises one or more of:
(i) checking the media for illegal content; and/or
(ii) checking the media for unauthorized or unlicensed content; and/or
(iii) checking whether the media violates terms of service of the booking platform; and/or
(iv) checking whether the media is already stored in the booking platform; and/or
(v) checking whether the media is from the location or was acquired at the location.

47. The computer-implemented method of claim 45, wherein the refund fee for the particular property was determined based on one or more of:
(a) a price for the particular property, wherein the price was determined after the second user selected the link; and/or
(b) time to check-in; and/or
(c) a length of stay associated with the particular property; and/or
(d) a probability of reselling the particular property; and/or
(e) a probability and/or rate of activation for the particular property; and/or
(f) an expected price and/or rate of resale of the particular property; and/or
(g) a desired profit margin; and/or
(h) location of the particular property; and/or
(i) amounts to be paid to partners; and/or
(j) the refund amount; and/or
(k) dates for the stay; and/or
(l) a number of guests the particular property can accommodate; and/or
(m) when or how the reservation was purchased.

48. The computer-implemented method of claim 45, wherein the link is in the media.
